(19) United States
(12) Patent Application Publication
(10) Pub. No.: US 2006/0174890 A1
(43) Pub. Date: Aug. 10, 2006

(54) Nasal adjuster

(75) Inventor: Yung-Chu Cheng, Taipei (TW)

Correspondence Address: TROXELL LAW OFFICE PLLC, 5205 LEESBURG PIKE, SUITE 1404, FALLS CHURCH, VA, 22041, US

(73) Assignees: Center Healthcare Technology Co., Ltd.; Shanghai Motex Healthcare Co., Ltd.

(21) Appl. No.: 11/340,667

(22) Filed: Jan. 27, 2006

(30) Foreign Application Priority Data
Feb. 4, 2005 (TW) 94202180

(51) Int. Cl. A62B 23/02; A62B 18/02

(52) U.S. Cl. 128/206.19; 128/206.21

(57) ABSTRACT

A nasal adjuster for adjusting the shape of a facemask comprises an outer edge for sticking against or fixing on the inner side of the facemask; an inner edge, configured to be conformable to the shape of a nose; wherein, when the user intends to wear the facemask, the user sticks first the nasal adjuster on the inner side of the facemask and then wear the facemask, whereby, through adjusting the curvature and shape of the facemask by means of said nasal adjuster, the facemask will not stick tightly over the mouth and nose, and the gap between the nose and the cheekbone can be filled so that the space of the gap can be reduced and the gas tightness of the nose can be increased, and hence the escape upwardly of mist through the gap can be lowered greatly so that the mist will not upwell to the eyes or glasses of the user, the sight of the user will not be obstructed further to affect indirectly his work, or the risk of blearing the sight of the user driving a vehicle will not be incurred, and thereby the safety can be assured, and at the same time, since the space between the facemask and the nose and mouth is increased, the purpose of increasing wearing comfort and safety can be attained.

### BACKGROUND OF THE INVENTION

1. Field of the Invention

The invention relates to a nasal adjuster for adjusting the shape of a facemask, and in particular, to a nasal adjuster conformable to human nose and capable of adhering to the inner side of a facemask in order to adjust the curvature of the facemask and to increase its comfort, while reducing the gap between nose and cheekbone in order to prevent foggy breath from escaping upwardly out of the gap, and hence can increase the air tightness and safety of the facemask.

2. Description of the Prior Art

Most of conventional ordinary facemask A, as illustrated in FIG. 1, is consisted of a facemask body A1 and two band bodies A2 fixed on both sides of said facemask body A1 made of a clothe of cotton material, where, by clasping said two band bodies A2 over two ears, respectively, the facemask A can cover the nose and mouth of a face and stick tightly over the face. However, a gap C is always formed between the nose and the cheekbone.

On the other hand, a commercial disposable planar facemask B is consisted of a facemask body B1 and band bodies B2 fixed on both sides of the facemask body B1, where a nasal line B3 is provided on the upper edge of the front side of said facemask body B1, wherein said nasal line B3 is made of metal or hard plastic material. When two band bodies B2 clasp over two ears, respectively, such that the facemask can cover the nose and mouth of the face, and stick tightly over the face, the user can pinch said nasal line B3 with fingers to adjust a curvature approaching the shape of the nose of user so as to increase the conform of the facemask B, thereby increase the safety of wearing a facemask.

Nevertheless, referring to FIGS. 2 and 2A in conjunction with FIG. 3, fog produced from breathing of the user will escape upwardly through the gap C between the nose and the cheekbone to the eye or glasses, where, if the user wears a glasses, the visual power of the user will be obstructed and hence the work will be affected. Further, as the user is driving a vehicle such as a motorcycle, a traffic accident tends to be happened due to poor sight.

Accordingly, there are marry disadvantages inherent in the manufacture and usage of the above-mentioned conventional product:
1. The nasal line B3 in the above-mentioned disposable facemask B tends to be floppy during its use and lose its action after a long-term use, and especially, owing to the pulling force front the band body B2, the nasal line B3 is readily to be relaxed find causes mass gas leakage.
2. When the user wears a glasses, as mist escaping-upwardly through the gap C between the nose and the cheekbone to the extent that the mist will spray over the eye or the glasses, and hence obstruct the sight of the user, the work of the user will be affected, and at this time moment, if the user is driving a vehicle such as a motorcycles a risk of traffic accident tends to occur.
3. Since the shape of nose varies from one to one, especially a high and big nose, the nasal line B3 cannot adjust fully based on the shape of the nose, such that a user with a high and big nose cannot overcome the gas leakage during wearing the facemask.
4. Because the above-mentioned conventional facemask may stick tightly over the mouth such that, as the user speaking, sound will be disturbed as it propagates by penetrating the facemask and hence the pronunciation will be unclear, and therefore, there is some difficulty in communication in case of wearing a facemask.

In view of the disadvantage in the use of the above described conventional facemask and various technical deficiencies derived therefrom, the inventor had devoted to improve and innovate, and finally, after studying intensively for many years, has developed successfully a nasal adjuster according to the invention.

### SUMMARY OF THE INVENTION

Accordingly, a primary object of the invention is to provide a nasal adjuster, and in particular, a nasal adjuster conformable to human body, which can stick securely to the inner edge of the facemask so as to adjust the curvature and shape of the facemask, thereby make breath more smooth and oral communication more convenient.

Another object of the invention is to provide a nasal adjuster that can be used to fill the gap between the nose and the cheekbone to reduce the space of that gap.

Yet another object of the invention is to provide a nasal with which the mist escaped upwardly through the gap during breathing can be greatly reduced.

Still yet another object of the invention is to provide a nasal adjuster with which the curvature and shape of the facemask can be adjusted such that a certain distance between the mouth and the facemask can be produced, thereby the inconvenience in speaking and the unclear pronunciation occurred when the user wears the facemask can be avoided.

Still another object of the invention is to provide a nasal adjuster which is disposable, in that it can adhered securely onto the inner edge of the facemask in use, and can be discarded after use, so as to meet requirements of health and environmental protection.

A further object of the invention is to provide a nasal adjuster which is made of softer material such as sponge, foam, fiber, plastic material and the like, thereby increase the comfort for the use wearing it.

The nasal adjuster that can achieve the above-described objects comprises mainly:

an outer edge, useful to stick or fix onto the inner side of a facemask;

an inner ledge, configured to conform the shape of a nose;

wherein a riding and attaching part is provided inwardly on lower end of the inner edge to rids over the nose;

and an adhesive or double-sided adhesive tape is applied on the outer edge in order to stick tightly on the inner side of the facemask.

As described above, when the user intends to wear the facemask, the user sticks first the nasal adjuster on the inner side of the facemask prior to wear the facemask, and then the curvature and shape of the facemask is adjusted by means of that nasal adjuster to prevent the facemask stick against the mouth and the nose, and at the same time, reduce the gap and increase the gas tightness of the nose to the extent that the mist escaped upwardly through the gap is minimized greatly, thereby mist can be prevent from escaping upwardly to reach eyes or glasses that may obstruct the sight of the user and hence affect the user's work, or to result in the risk of blearing during driving a vehicle. Therefore, by using the nasal adjuster according to the invention, the purpose of increase comfort and provide high safety can be attained.

### BRIEF DESCRIPTION OF THE DRAWINGS

These and other features and advantages of the present invention will be fully understood and appreciated from the following detailed description of the accompanying Drawings:

FIG. 1 is a schematic view of a conventional facemask;

FIG. 1A is a top view of the facemask shown in FIG. 1;

FIG. 2 is a schematic view of a conventional disposable facemask;

FIG. 2A is a top view of the facemask shown in FIG. 2;

FIG. 3 is a schematic view showing the escaping upwardly of mist through the gap in the facemask;

FIG. 4 is a schematic view showing the structure of the nasal adjuster according to the invention;

FIG. 4A is the top view of the nasal adjuster shown in FIG. 4;

FIG. 5 is a schematic view showing the practice of the nasal adjuster according to the invention,

FIG. 5A is a top view showing the practice of the nasal adjuster showing in FIG. 5;

FIG. 6 is a schematic view showing the nasal adjuster of another embodiment according to the invention;

FIG. 7 is a schematic view showing the state of the nasal adjuster according to the invention before it is folded with a facemask;

FIG. 7A is a schematic view showing the folded nasal adjuster and the facemask.

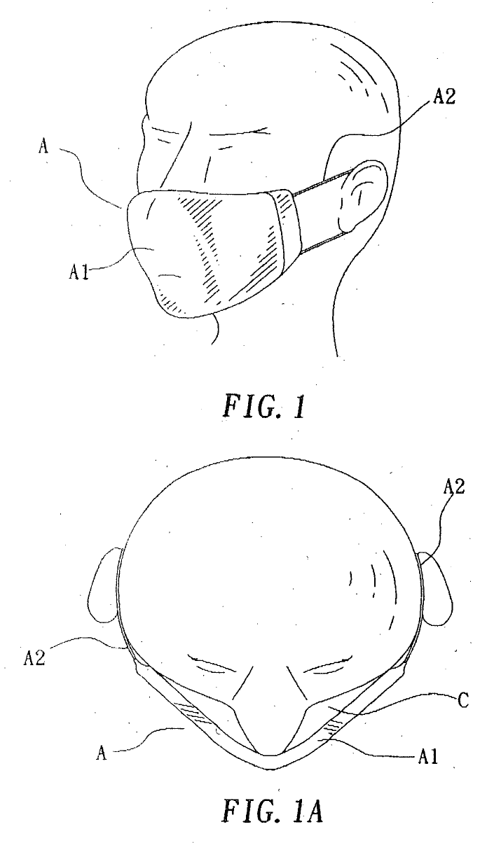

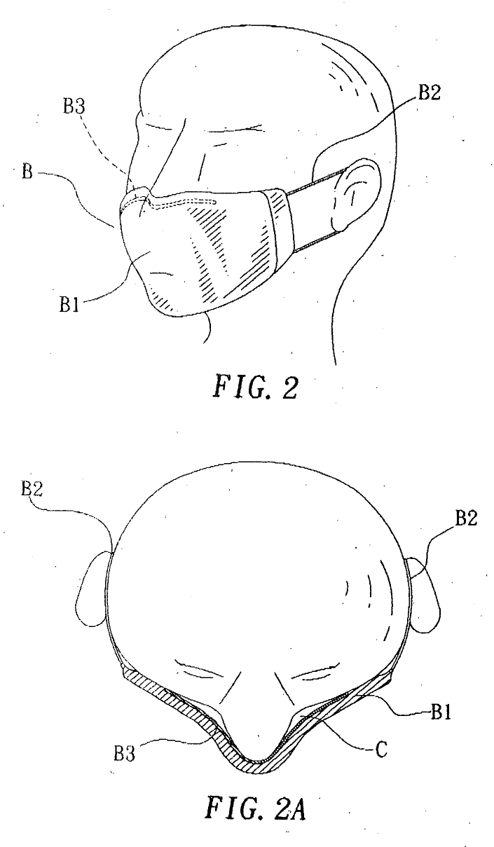

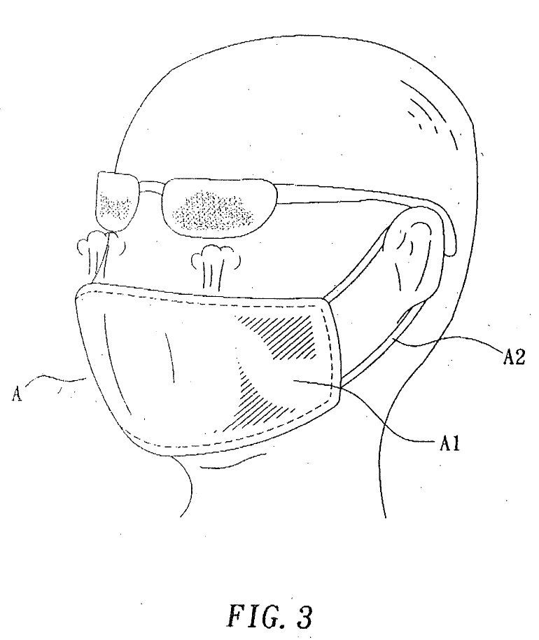

### SYMBOLS OF MAIN ELEMENTS

A Facemask
A1 Facemask body
A2 Band body
B Facemask
B1 Facemask body
B2 Band body
B3 Nasal line
1 Nasal adjuster
11 Outer edge
12 Inner edge
121 Notch
13 Riding and attaching part
14 Adhesive
2 Facemask
21 Band body
3 Nose
4 Mouth

### DETAILED DESCRIPTION OF THE PREFERRED EMBODIMENT

In order to better understand the structure, usage and feature of the nasal adjuster according to the invention, preferred embodiments are provided in conjunction with the accompanied drawings as follows.

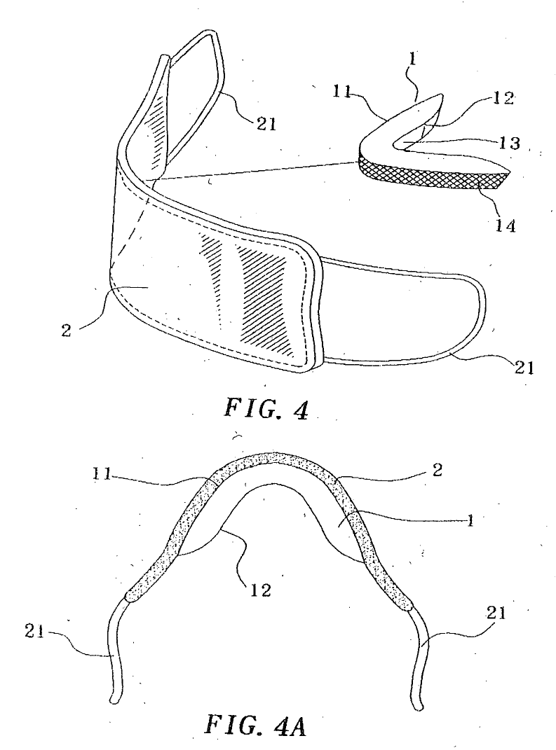

Referring to FIGS. 4 and 4A, the invention provides a nasal adjuster 1, comprising:

an outer edge 11, for sticking against or fixing on the inner side of the facemask 2;
an inner edge 12, configured to conform to the shape of the nose;
   wherein, said inner edge 12 is provided with a riding and attaching part 13 to riding over the nose 3, and wherein said nasal adjuster 1 is made of soft material or elastic material such as rubber, foam, fiber, plastic material and the like) to reduce the pressure on the nose 3, and increase the comfort in wear, and wherein said outer edge 11 is applied with an adhesive 14 or double-sided adhesive tape for sticking securely on the inner side of the facemask 2.

As described above, when the user intends to wear the facemask 2, the outer edge 11 of said nasal adjuster 1 can be coated with an adhesive 14 to stick said nasal adjuster 1 onto the inner side of the facemask 2 such that said nasal adjuster 1 can be fitted intimately with said facemask 2, thereby the curvature and shape of the facemask 2 can be adjusted-such that a certain distance can be generated between said facemask 2 and the mouth 4 to not let the facemask stick tightly over the mouth 4 and hence can breath smoothly, speak more conveniently, and no unclear pronunciation will occur in speaking during wearing a facemask 2.

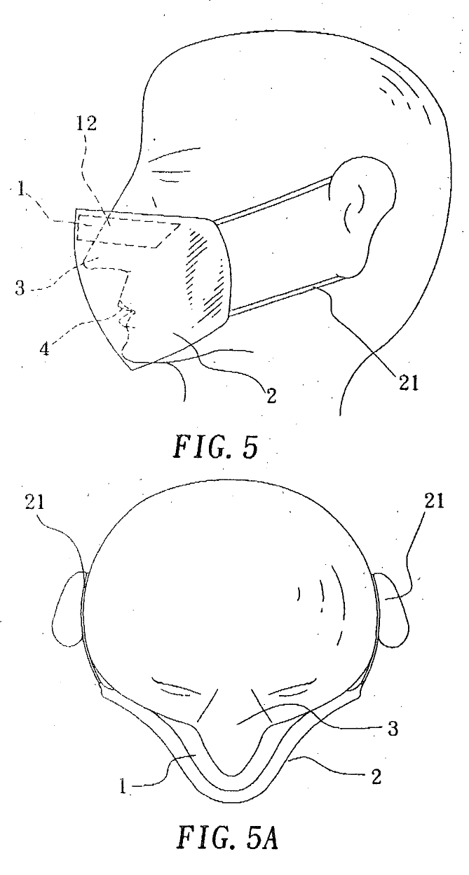

Referring to FIGS. 5 and 5A, when the facemask 2 is to be worn, the inner edge 12 of the nasal adjuster 1 is placed over the nose 3 in a manner that said nasal adjuster 1 sticks against the nose 3, and at the same time, by clasping said band bodies 21 over two ears, respectively, the facemask 2 can cover over the mouth 4 and the nose 3, and sticks tightly over the face, where the gap between the nose 3 and the cheekbone can be filled by means of said nasal adjuster 1, thereby the spacing of the gap can be reduced so as to decrease greatly the mist escaping upwardly through the gap such that the mist will not upwell to the eyes or glasses of the user and not obstruct the sight of the user to affect his work, and can reduce the risk of the user driving a vehicle so as the assure the safety.

In a preferred embodiment, the inner edge 12 of the nasal adjuster 1 can be placed directly over the nose 3 such that the riding and attaching part 13 of the inner edge 12 can stick against the nose 3, thereby, in wearing the facemask 2 subsequently, the gap between the nose 3 and the cheekbone can be filled by said nasal adjuster 1 to reduce the escaping of mist through said gap.

In one embodiment, the above-described nasal adjuster 1 is in a disposable form that it can self-stick securely on the inner side of the facemask during use, and can be discarded after use to meet the requirement of health and environmental protection.

In an ideal embodiment, said nasal adjuster 1 can bind directly with the facemask 2 into an integral body to let the user wear more easily and hence increase further its convenience.

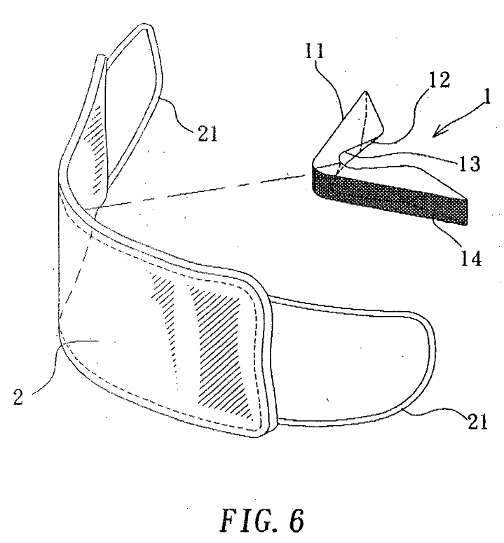

In another embodiment of the invention, referring to FIGS. 6 ad 7, said nasal adjuster 1 can be in a foldable form, and comprises:

an outer edge 11, for taxing on the inner side of the facemask 2;

an inner edge 12, configured in a shape conformable the shape of the nose;

wherein said inner edge 12 is provided at its lower, end with a riding and attaching part 13, and said inner edge 12 is provided at its middle position with a notch 121 for buffering the impact therebetween in the folding.

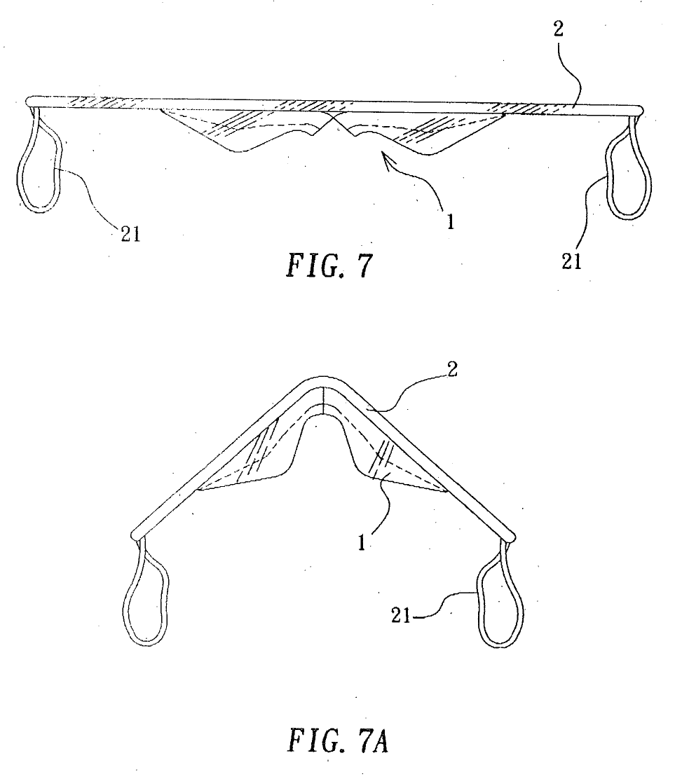

As shown in FIGS. 7 and 7A, the outer edge 111 of the nasal adjuster 1 is fixed on the inner side of the facemask 2, and, in the time of normal storage, is parallel each other. When the user intends to wear the facemask 2, the user can fold the facemask 2 inwardly, such that both sides of the notch 121 contact each other to result the inner edge 12 into a nose-like shape, and then, places the nasal adjuster 1 over the nose 3 to fill the gap between the nose 3 and the cheekbone and to reduce greatly the escape of mist upwardly. To withdraw it, the nasal adjuster 1 and the facemask 2 are just to be outspread into parallel state, or it can be token off and tucked rapidly and conveniently

By fixing directly the inventive nasal adjuster 1 on the inner side of the facemask 2 to adjust the curvature and shape of the facemask 2, the breath can be smoother, speaking more convenient, and the gap between the nose 3 and the cheekbone can be filled to reduce the space of the gap, thereby, the escape of mist upwardly through the gap, can be lowered greatly, and the unclear pronunciation occurred in speaking of the user wearing the facemask 2 can be improved. On the other hand, said nasal adjuster 1 can be in disposable form that can be discarded after use, thereby meets requirement of health and environmental protection and achieves the purpose of low cost and high utility, and improving the comfort and safety in wearing.

While the foregoing has described the preferred embodiments of the invention, it is understood that it is not intended to limit the scope of the invention. Equivalent changes duct modifications made in view of the disclosure set forth in the specification and the appended claims are intended to be fallen within the scope of the invention as defined by the appended claims.

What is claimed is:

1. A nasal adjusters comprises:
an outer edge, for sticking against or fixing on the inner side of a facemask;
an inter edge, configured to be conformable to the shape of a nose.

2. A nasal adjuster as recited in claim 1, wherein said inner edge is provided at its lower end with a riding and attaching part.

3. A nasal adjuster as recited in claim 1, wherein said nasal adjuster is made of a soft material.

4. A nasal adjuster as recited in claim 1, wherein said nasal adjuster is made of an elastic material.

5. A nasal adjuster as recited in claim 1, wherein the material used to make said nasal adjuster is a rubber material.

6. A nasal adjuster as recited in claim 1, wherein the material used to make said nasal adjuster is a foam material.

7. A nasal adjuster as recited in claim 1, wherein the material used to make said nasal adjuster is a fiber material.

8. A nasal adjuster as recited in claim 1, wherein the material used to make said nasal adjuster is a plastic material.

9. A nasal adjuster as recited in claim 1, wherein said outer edge is applied with an adhesive to stick on the inner side of a facemask.

10. A nasal adjuster as recited in claim 9, wherein said adhesive is a double-sided adhesive tape.

11. A nasal adjuster as recited in claim 1, wherein said nasal adjuster binds directly with a facemask and fixed into an integral body.

12. A nasal adjuster, comprises:
an outer edge, for sticking on the inner side of a facemask;
an inner edge, configured to be conformable to the shape of a nose.

13. A nasal adjuster as recited in claim 12, wherein said inner edge is provided at its lower end with a riding and attaching part.

14. A nasal adjuster as recited in claim 12, wherein said inner edge is provided at its middle position with a notch.
